(19) United States
(12) Patent Application Publication
(10) Pub. No.: US 2023/0351311 A1
(43) Pub. Date: Nov. 2, 2023

(54) Reconfigurable Packaging System for Compact and Efficient Transport of Temperature-Sensitive Payloads and Optional Emptied Return Shipment

(71) Applicant: MaxQ Research, Stillwater, OK (US)

(72) Inventors: Saravan Kumar Shanmugavelayudam, Stillwater, OK (US); Arif Rahman, Stillwater, OK (US); Balaji Jayakumar, Stillwater, OK (US); Shoaib Shaikh, Stillwater, OK (US); Murthy Lakshmi Narasimha Doodasomayajula, Stillwater, OK (US)

(73) Assignee: MaxQ Research, Stillwater, OK (US)

(21) Appl. No.: 18/141,598

(22) Filed: May 1, 2023

Related U.S. Application Data
(60) Provisional application No. 63/337,114, filed on May 1, 2022.

(51) Int. Cl. G06Q 10/0832; B65D 81/38

(52) U.S. Cl. CPC G06Q 10/0832; B65D 81/38

(57) ABSTRACT

A packaging system for shipping temperature-sensitive payloads to an end-user which is reconfigurable for optional easy, efficient and cost-effective empty return shipping by the end-user.

### BENEFIT OF FILING DATE OF EARLIER-FILED APPLICATION

This non-provisional patent application claims benefit of the filing date of U.S. Provisional Patent Application 63/337,114, our docket FGPMXQ22BP, which was filed on May 1, 2022.

### INCORPORATION BY REFERENCE

U.S. Provisional Patent Application 63/337,114, our docket FGPMXQ22BP, filed on May 1, 2022, is incorporated by reference in its entiriety, including diagrams, into the present patent application.

The following publications are incorporated by reference into the present disclosure, including their drawings:
a. “Pilot Study: MaxPlus PharmaPack SP™: A Summary of Findings”, copyright 2022, by MaxQ Research of Stillwater, Oklahoma, USA.
b. “MaxPlus Thermal Control Transport Systems”, copyright 2022, by MaxQ Research of Stillwater, Oklahoma, USA.
c. “MaxPlus PharmaPack SP”, copyright 2022, by MaxQ Research of Stillwater, Oklahoma, USA.

### FIELD OF THE INVENTION

The present invention relates to packaging systems for shipping, transport, handling, and logistics of temperature sensitive payloads such as, but not limited to, medicines, biologics, and food products, with improved reconfigurability for optional return shipping of the emptied packaging system.

### BACKGROUND OF THE INVENTION

A trend toward direct-to-patient specialty medication delivery has been growing for several years, which has only been accelerated by COVID-19 restrictions. These medications are often biologics and must be kept within strict temperature ranges. For specialty pharmacies this has meant purchasing and storing bulky, expensive and single-use packaging solutions cumbersome for both pharmacists and patients—and incurring increasing inbound and outbound freight costs, as well as negative environmental impact.

### SUMMARY OF THE INVENTION

A packaging system for shipping temperature-sensitive payloads to an end-user which is reconfigurable for easy, efficient and cost-effective return shipping by the end-user.

### BRIEF DESCRIPTION OF DRAWINGS

The figures presented herein, when considered in light of this description, form a complete disclosure of one or more embodiments of the invention, wherein like reference numbers in the figures represent similar or same elements or steps.

FIG. 1 illustrates an example embodiment according the invention with a lid panel open showing a pre-determined pack-out of a payload.

FIG. 2 sets forth the first 3 steps of a process to prepare and assemble an example embodiment for shipping a temperature-sensitive payload.

FIG. 3 continues the example process of FIG. 2 including performing a pre-determined pack-out process for a specific payload type.

FIG. 4 continues the example process of FIGS. 2 and 3 including insertion of return shipping instructions and materials, and final closure in preparation for shipping.

FIG. 5 shows an example embodiment according to the present invention of a final configuration packed and ready to ship.

### DETAILED DESCRIPTION

The present inventor(s) have recognized that existing shipping methods, processes, and packages are insufficient for meeting the demands of the modern pharmacy and consumer, especially with respect to delivering temperature-sensitive products from a pharmacy, such as a retail store or a centralized prescription fulfillment center, to a patient, such as a residential address. Consumers (patients) are sensitive to the waste they observe in one-time-use product packaging, such as a non-reusable thermal boxes and non-reusable frozen packs. Shipping companies add a premium to large volume (three-dimensional displacement), low-weight shipments, such as a return shipments of empty cartons. And, pharmacies have limited space to store rigid, nesting containers and limited available cost overhead to absorb additional shipping cost for the weight of such containers.

Many of the medications specialty pharmacies dispense are biologics, which means the payloads must be kept within strict temperature ranges so they don't get too hot or too cold. This requirement is easy enough to meet when storing them onsite in refrigerators—but involving complicated logistics when sending out to patients, including the last leg of transit from the pharmacy to the end-user (consumer, patient).

For these reasons, and to meet these unfulfilled needs in the market, the present inventors have designed and tested for technical performance as well as for consumer acceptance a class of purpose-built shipping containers for temperature sensitive biologics. A proper cold transportation chain needs to consider a range of factors, including the climate and season of where medication is being dispensed as well as where it's going. It also needs to take into account unexpected supply chain disruptions like severe weather events or even a global pandemic that can slow delivery. The one or more example embodiments of the present invention can meet all of these requirements in a cost effective, environmentally senstive and consumer-accepting manner.

The containers of the present invention simplify direct-to-patient delivery of such temperature-senstive products. The various embodiments provide a range of easy-to-use cold chain solutions which eliminate the need for multiple or seasonal pack-outs. The packing systems can be pre-qualified to hold precise temperatures for specific payloads during transport, using standardized packing protocols, no matter what time of year or the destination, to save time and make training staff easier.

At least one advantage of some embodiments according to the present invention provides multipurpose solutions for optimum efficiency in which the packaging systems of the present invention are designed specifically to help specialty pharmacies streamline processes and cut costs to ship medications with any temperature maintenance profile from controlled room temperature (CRT) to refrigerated. At least one embodiment of the present invention has been performance qualification (PQ) tested to support Utilization Review Accreditation Commission (URAC) accreditation.

Specific Embodiment Examples. At least one prototype design according to the present invention has been fabricated, performance-verified in a laboratory environment, and field tested with a set of beta-test consumers using real logistics handling services. In particular, this at least one prototype design:
Reduces shipping costs by decreasing dimensional weight of the packaging system, potentially as much as 50%
Environmentally friendly—recycle or return for reuse
36-hour model qualified for 36 hours summer or winter
48-hour model qualified for up to 36 hours in summer, up to 48 hours in winter
Universal all-season packout design simplifies packing process
Reduces storage space requirements within pharmacy and reloads by couriers
Meets all URAC 4.0 requirements

Designed for expedited transport of specialty pharmacy medication, the prototype packaging system delivers quality performance in a compact container. At least two example sizes (outer dimensions) allow for temperature-controlled shipping and delivery for up to 36 hours or up to 48 hours at refrigerated temperatures. The example embodiments are up to 75% smaller and 50% lighter than current specialty pharmacy logistics solutions, which can reduce shipping costs by as much as 50%. Additionally, since less storage space is needed—the specialty pharmacy operating environment becomes more efficient.

To maximize cost efficiencies further, the packaging system is qualified for universal, all-season packouts so pharmacies can perform PQ testing once a year. The standardized packaging system can be assembled in seconds, eliminating the need for staff retraining or operational adjustments during seasonal transitions. The packaging system is designed specifically for specialty pharmacy shipments, and is tested to ISTA 7D and 7E profiles.

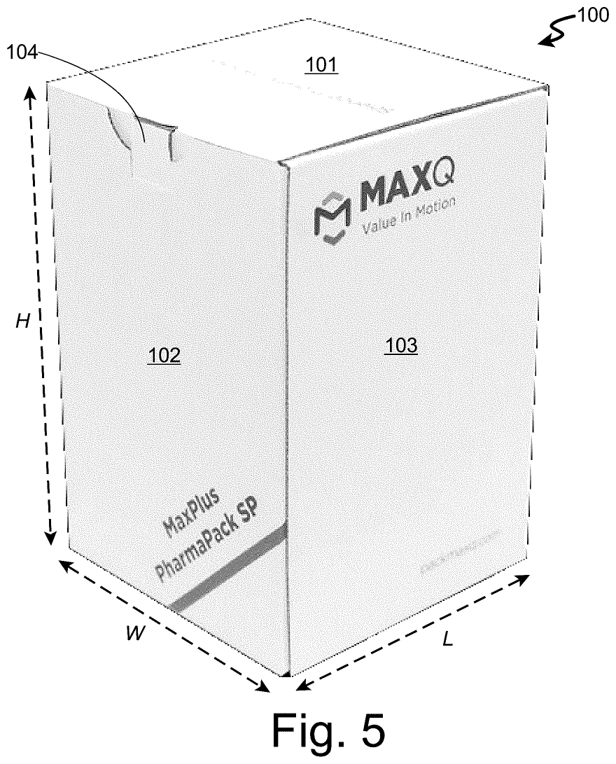

Referring to FIG. 5, the outer appearance of the example embodiment 100 is unassuming and ordinary, having a top lip flap 101, a front panel 102, a right side panel 103, and a rear panel, a bottom panel and left side panels which are not visible in this view, and an optional latching device 104. This example embodiment's outer dimensions for a 1.4 liter capacity include 6.0 inches in length (L) by 6.0 inches in width (W) by 8.9 inches in height (H) for a 36-hour pre-qualified package. For a 1.4 liter capacity pre-qualified package for 48-hour transportation, the outer dimensions only increase by about half an inch to 6.5×6.5×9.3, respectively.

The following method of use, assembly and disassembly will also explain the components of the design of this example embodiment to illustrate the invention in detail. Other dimensions, sequences of materials, and configurations are available within the scope of the present invention.

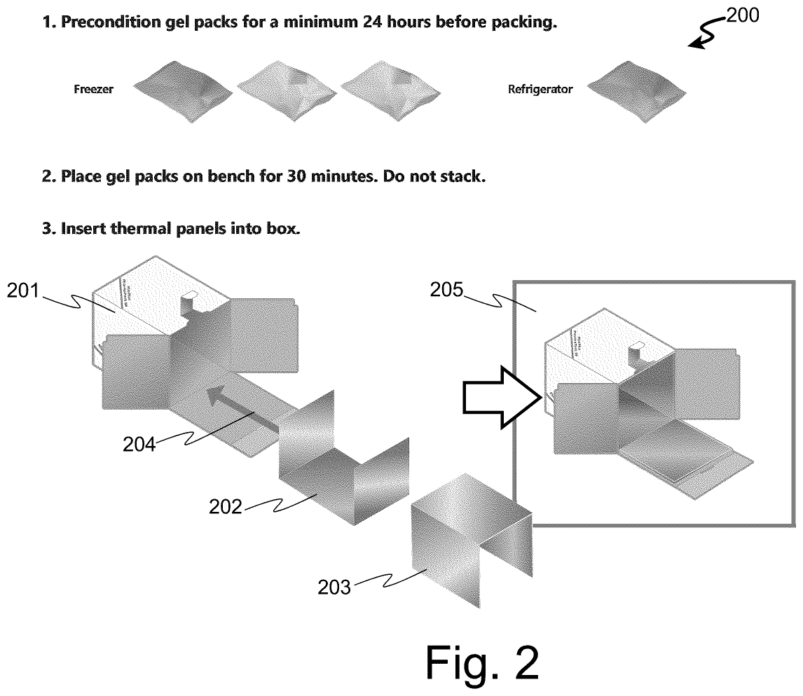

Referring now to FIG. 2, one or more gel packs, such as but not limited to a phase change material (PCM) packs, are preconditioned 200 for a minimum time, such as 24 hours, using a freezer or a refrigerator or both, prior to using the packaging system. Just prior to packing the payload into the packaging system, the one or more gel packs are placed on a bench top for a pre-determined period of time, such as 30 minutes, without stacking them on each other.

Next, the outer carton 201 is assembled in an conventional manner, such as folding, unfolding, bending, taping, gluing, etc., to produce an interior space with one or more open top panels. One or more thin, high performance thermal insulation panels 202, 203 which are designed to pack flat when not in use (i.e., before or after shipping is completed) are prepared by bending a rectangular thermal insulation sheet at designated lines, such as scored lines, to yield a thermal liner which is proportioned and sized to fit as a liner in the interior volume of the carton 202 when assembled. This particular embodiment uses a two-component thermal liner which completely flattens into two rectangular sheets to reduce the size of the return-shipment package. When assembled, this particular embodiment has two U- or C-shaped components, as shown, which nest into each other to produce a fully enclosed thermal liner, which is easily inserted 204 into the assembled outer carton 201, as shown 205.

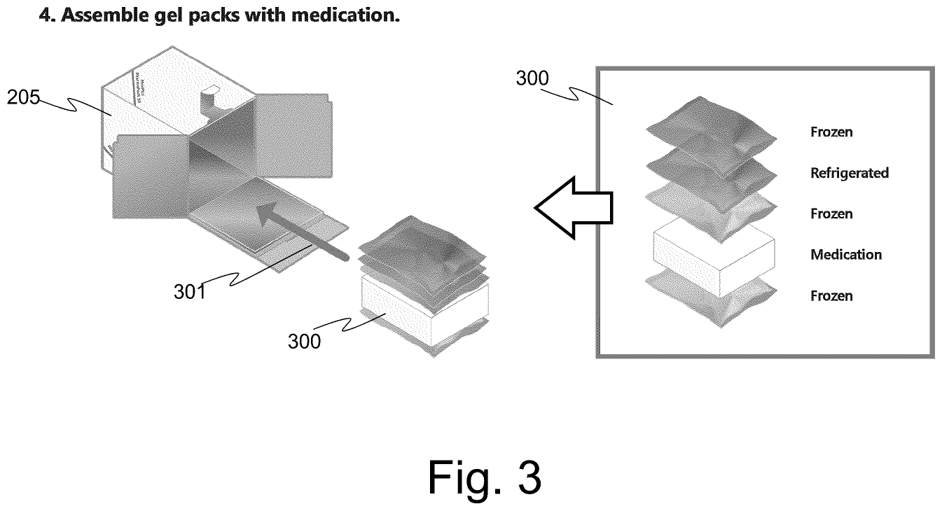

Referring now to FIG. 3, a pre-determined “pack-out” assembly 300 of the payload is made, such as a specific stack of the pre-conditioned thermal packs on one or more sides of a thermally-sensitive product (box, bottle, bag, etc.). In this example, a thermally-sensitive medication in a box is placed between one or more froze, refrigerated, or both, gel packs, and then the packed-out payload is inserted 301 into the assembled outer carton and thermal liner 205. In other methods, the pack-out assembly may be wrapped in the thermal liner, and then the loaded thermal liner may be inserted into the outer carton, etc.

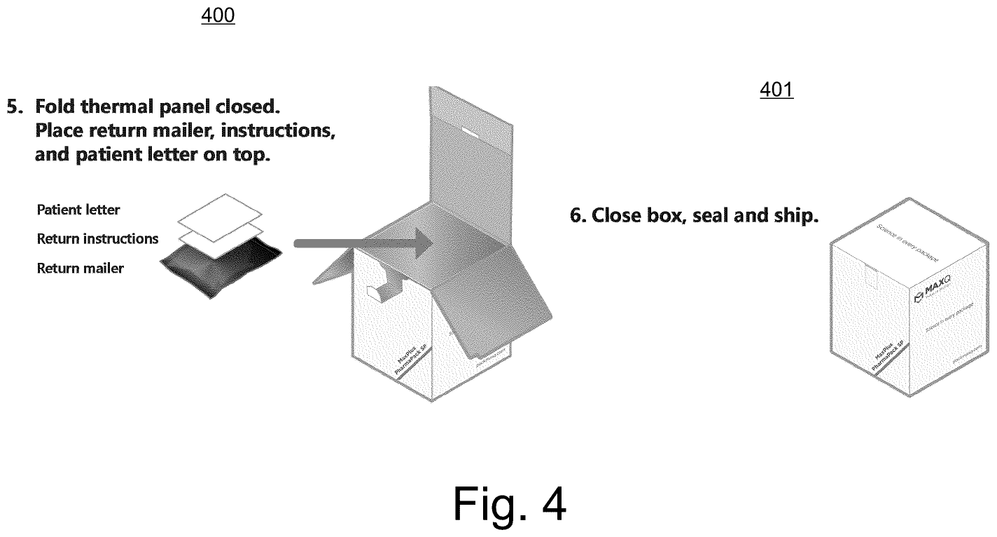

Referring now to FIG. 4, the open panel of the thermal liner is closed 400 over the packed-out payload and optional return shipping materials are placed on top of the thermal liner, such as instructions, shipping label and a flattened return shipment bag or envelope. Then, the top lid 101 is closed and optionally the latching device 104 is engaged to secure the lid, which renders the packaging system ready for shipment 401 as illustrated in FIG. 5.

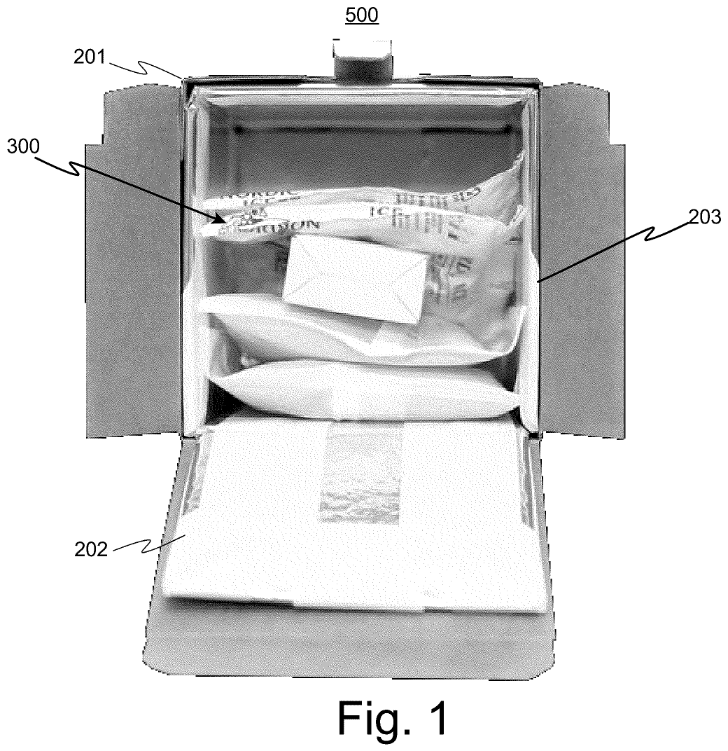

An example filled packaging system 500 according to this embodiment is shown in FIG. 1 with the top lid and the top insulating panel open. In this view, the outer carton and thermal liner relationship is evident, as well as the pre-determined packout of the thermally-sensitive product (e.g., box, bottle, bag, tube, etc.) sandwiched between (or next to) one or more frozen or refrigerated packs.

The end-user (i.e., patient, consumer, etc.) can easily remove the return shipping materials, remove the payload, remove the thermal liner, flatten the thermal liner, and flatten the outer carton. Then, the flattened thermal liner and outer carton can be placed into the return shipping bag or box along with the gel packs, and the return shipping label, if provided, can be affixed to prepare the used packing system for compact, efficient and cost-effective return shipping to the pharmacy, wholesaler, supplier or distributor.

Laboratory and Field Testing Results. As an integral part of the development process for a packaging system such as the present invention, the inventors concluded that real-life or real-world testing would be required to validate and prove the performance of the designs beyond the controlled environment of laboratory tests. The following paragraphs summarize such tests and their results, which further enable the reader to understand the present invention and the one or more example embodiments disclosed herein. The invention is not limited to the one or more test scenarios described herein, however, as those ordinarily skilled in the art will readily recognize.

To validate the efficacy of the packout, a pilot study was conducted with patients of specialty pharmacies strategically selected for their different climates and geography. A total of 755 prototype packaging systems were distributed to eight specialty pharmacies across the United States. Over an eight-week period, pilot study participants used the prototype packaging system for their refrigerated medication shipments to patients in Rochester, NY; Buffalo, NY; Fort Wayne, IN; Los Angeles, CA; Vancouver, WA; Fort Myers, FL; and Hershey, PA. The results of the pilot study indicated that the thermal management requirements to protect the payload were met, and that consumers found the unpacking and return shipping process easy to perform and satisfying to complete.

Feedback was collected via an online survey, email and phone interviews. Among the feedback from the Specialty Pharmacy users were the following comments:
(a) “Using the [prototype packaging system] for 35 shipments, we have saved approximately 24% in shipping costs compared to our traditional coolers. This was for in state shipping and export shipping to all 50 states. The majority of our shipments are in state. If we only looked at our out of state shipments, our savings would be closer to 42% savings.
(b) “We can actually walk through our pharmacy now that there are not insulated boxes all over the place. We ship 40 boxes out per day and we can fit all of them on a small desk to prepare for packout”
(c) “We don't have to worry about bubble wrap or craft paper anymore? Just do the packout and ship it?”
(d) “When our current vendor ships us 1200 boxes it takes up 15 pallets on a truck. It looks like using the [prototype packaging system] system it will only be 3 pallets. That is cost savings for the pharmacy as well as extra space in the pharmacy”.

Among the feedback from the end users (patients, consumers, etc.) were the following comments:

Question 1: What did you like best about the MaxPlus PharmaPack SP?
Smaller size: 14% agreed
Reduced environmental impact: 36% agreed
All of the above: 43% agreed

Question 2: Ease of return and reuse: 100% of patients said they would send the shipper back to the specialty pharmacy if provided with a pre-printed return mailer bag.

Question 3: How is the size and weight of the protoytpe packaging system?
(a) “This was the first time I could carry the box in from the front porch without help.”
(b) “I liked the smaller cooler, and especially that it can be recycled or reused.”

Question 4: Regarding ease of accessing the medication in package, 93% said they found the package easy to open.

Electronic Sensing and Tracking. Optionally, one or more on-board temperature sensors, data loggers, and/or wireless tracking modules may be provided with, on or in the packaging system to enable improved confidence in the shipping process and optimization for handling systems, route planning, etc. Such sensors can be wired, wireless (e.g., RFID, NFC, etc.), or a combination of both, and may be used to sense the payload temperature or the ambient temperature outside the package, or both.

Thermal Liner Materials. There are many thermal liner materials which are thin enough and light enough to meet the objectives of the present invention. In particular, the present inventors have used, tested and verified the performance of at least these materials:
a. vaccuum insulated panels;
b. PopupLiner [TM] recycled polyuraethane foam with a metalized polyester cover combined with PE Safe,available from Insulated Products Corporation of Rancho Dominguez, California, USA.; and
c. CelluLiner [TM] recyclable paper insulation, available from Insulated

Products Corporation of Rancho Dominguez, California, USA.

These insulation materials can be used separately or in combination with each other to produce the thermal lining of the present packaging system invention, as well as other equivalent materials from this and other manufaturers.

Conclusion. The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof, unless specifically stated otherwise.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. The foregoing example embodiments do not define the extent or scope of the present invention, but instead are provided as illustrations of how to make and use at least one embodiment of the invention.

1. A reconfigurable package system for shipping a thermally-sensitive product:
at least one outer carton which has a disassembled configuration into a flat form, and an assembled configuration into a carton with a lid defining a volume within the carton configured to receiving a thermal liner, a return package, and a thermally-sensitive product;
at least one inner thermal lining component which has a disassembled configuration into a flat form, and an assembled configuration into a thermally-insulated enclosure which fits within the volume of the assembled outer carton and which itself defines a thermally-insulated volume for receiving at least the thermally-sensitive product; and
a least one return package which has a disassembled configuration to be received into the assembled outer carton, and an assembled configuration as a shipping package which defines a volume configured to receive the disassembled outer carton and the disassembled inner thermal lining for return shipping of the reconfigurable package system for reuse.

2. The reconfigurable package system as set forth in claim 1 wherein the at least one inner thermal lining component comprises one or more thin, high performance thermal insulation panels.

3. The reconfigurable package system as set forth in 2 wherein the one or more thin, high performance thermal insulation panel comprise polyuraethane foam with a metalized polyester cover.

4. The reconfigurable package system as set forth in 2 wherein the one or more thin, high performance thermal insulation panel comprise paper insulation.

5. The reconfigurable package system as set forth in claim 2 wherein the thermal insulation panels comprise two interlocking panels having a C-shape.

6. The reconfigurable package system as set forth in claim 1 further comprising one or more gel packs, and wherein the outer carton and the inner thermal lining are further configured to define volumes to receive the one or more gel packs.

7. The reconfigurable package system as set forth in claim 6 wherein the one or more gel packs comprises one or more phase change material (PCM) packs.
